(19) United States
(12) Patent Application Publication
(10) Pub. No.: US 2021/0012343 A1
(43) Pub. Date: Jan. 14, 2021

(54) SYSTEMS AND METHODS FOR USE IN FACILITATING NETWORK INTERACTIONS

(71) Applicant: MASTERCARD INTERNATIONAL INCORPORATED, PURCHASE, NY (US)

(72) Inventors: Marcelo Theodoro, New York, NY (US); Eve Makarova, Dublin (IE); Onur Burak Ozkan, Dublin (IE); Olga Bogomolova, Staten Island, NY (US)

(21) Appl. No.: 16/922,803

(22) Filed: Jul. 7, 2020

Related U.S. Application Data
(60) Provisional application No. 62/871,468, filed on Jul. 8, 2019.

(51) Int. Cl. G06Q 20/40; G06Q 20/38; G06Q 20/32; G06Q 20/42

(52) U.S. Cl. CPC G06Q 20/4014; G06Q 20/38215; G06Q 20/425; G06Q 20/3223; G06Q 20/389

(57) ABSTRACT

Systems and methods are provided for facilitating network transactions. One exemplary computer-implemented method includes compiling a list of accounts for a user and, for each of the accounts, appending a network scheme identifier to either the account or a profile for the user in association with the account, where the network scheme identifier is indicative of a network to which the account is associated. The method also includes receiving a selection of one of the accounts from the list of accounts in connection with a checkout and identifying the network associated with the selected account based on the network scheme identifier for the selected account. The method then includes transmitting at least one message associated with the checkout to a software development kit (SDK) and/or an application programming interface (API) of the identified network, thereby allowing the identified network to process a network transaction in connection with the checkout.

### CROSS-REFERENCE TO RELATED APPLICATION

This application claims the benefit of, and priority to, U.S. Provisional Application No. 62/871,468 filed on Jul. 8, 2019. The entire disclosure of the above-referenced application is incorporated herein by reference.

### FIELD

The present disclosure generally relates to systems and methods for use in facilitating network interactions, whereby software development kits (SDKs) are employed to facilitate the network interactions to multiple different networks.

### BACKGROUND

This section provides background information related to the present disclosure which is not necessarily prior art.

Users are known to purchase products (e.g., goods, services, etc.) from first parties, either at physical locations of the first parties or at virtual locations of the first parties. In connection with the purchases, the users, also referred to herein as consumers, are known to employ different means of funding the transactions, including credit cards, debit cards, checks, cash, etc. When using credit cards, or more broadly, payment accounts, to fund purchases at virtual first party locations (e.g., websites, etc.), it is known for users to provided payment account credentials for their credit cards, whereby the first parties are permitted to initiate payment account transactions to fund the purchases of the products.

It is also known for the first parties to interact or integrate with virtual wallet platforms, whereby the users are able to provide their payment account credentials to the first parties through the virtual wallet platforms. It is further known for first parties to rely on payment service providers (PSPs) to facilitate transactions for the products on behalf of the first parties in response to receipt of such payment account credentials.

### DRAWINGS

The drawings described herein are for illustrative purposes only of selected embodiments and not all possible implementations, and are not intended to limit the scope of the present disclosure.

FIG. 1 illustrates an exemplary system of the present disclosure suitable for use in facilitating secure remote commerce (SRC) transactions by users at virtual locations associated with first parties, to multiple different payment networks, through payment service providers (PSPs);

FIG. 2 is a block diagram of a computing device that may be used in the exemplary system of FIG. 1;

FIG. 3 is an exemplary method that may be implemented in the system of FIG. 1 for facilitating a SRC transaction by an existing, recognized user at a virtual location of a first party, to multiple different payment networks, through a PSP;

FIG. 4 is an exemplary method that may be implemented in the system of FIG. 1 for facilitating a SRC transaction by an existing, unrecognized user at a virtual location of a first party, to multiple different payment networks, through a PSP; and

FIG. 5 is an exemplary method that may be implemented in the system of FIG. 1 for facilitating a SRC transaction by a new, unrecognized user at a virtual location of a first party, to multiple different payment networks, through a PSP.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Virtual locations such as, for example, websites, network-based applications, etc., may be associated with first parties (e.g., merchants, etc.) and may include functionalities to improve checkout experiences of consumers at the first parties. When the virtual locations interact with the consumers, through a payment service provider (PSP), the PSP may include remote payment options as part of the consumers' experiences with the first parties. The remote payment options may be specific to a payment network, or specific to a virtual wallet platform. When a remote payment option involves multiple payment networks, it is necessary for the PSP to communicate with each of the payment networks via the specific channels of communication offered from the payment networks (where each may have their own specific formats or protocols, etc.). Consequently, the PSP is required to adapt to the different payment networks through the development of facilitating software. For example, a PSP may interact with multiple different application programming interfaces (APIs) for remote commerce and further with additional software development kits (SDKs) for client-side support to accommodate all parties involved.

Uniquely, the systems and methods herein provide a SDK, or multiple SDKs (e.g., in a package, etc.), for use by the PSP (broadly, a remote payment platform), to identify and route messaging related to checkout and/or transactions to an appropriate payment network among multiple different payment networks (based on the payment accounts used in the transaction) and to, when necessary, map or translate messaging to network specific messaging in a form consistent with the SDKs and/or APIs of the different payment networks. In particular, remote payments rely on different manners of interactions with different payment networks. The SDK(s) described herein is/are implemented at the PSP (or merchant) and provide a single point of interaction to reach each of multiple different payment networks. In this manner, the PSP (or merchant) is only required to integrate its payment interfaces with the single SDK (or package of SDKs), for certain operations, whereby the SDK(s) identify the payment network to which messaging is to be directed and coordinate mapping of messaging to the specific payment networks, initially, and also as each is updated and/or changed by the different networks. Therefore, integration of the multiple different payment networks, as payment options, is contained within the SDK(s) thereby alleviating the PSP (or merchant) from difficulties and efforts related to payment network specific changes, revisions and/or differing software.

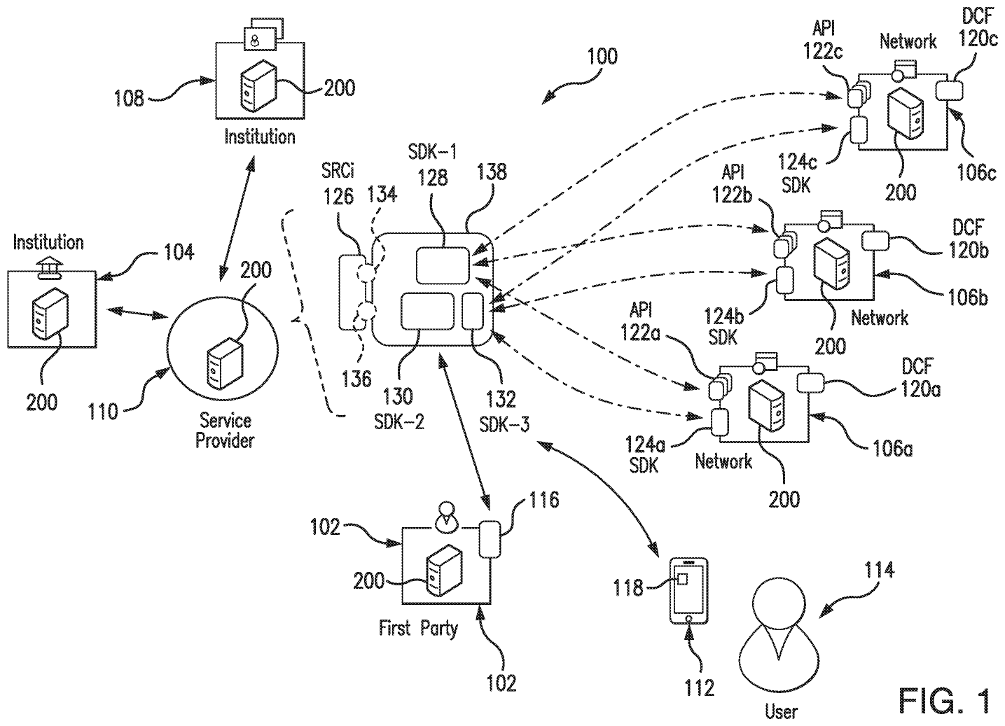

FIG. 1 illustrates an exemplary system 100 in which one or more aspects of the present disclosure may be implemented. Although the system 100 is presented in one arrangement, other embodiments may include systems arranged otherwise depending, for example, on processing of payment account transactions, first parties involved in payment account transactions, involvement of PSPs in transactions, numbers and/or types of payment networks included in the systems, privacy concerns, etc.

In the illustrated embodiment, the system 100 generally includes a first party 102, a banking institution 104, three payment networks 106a-c, a banking institution 108, and a service provider 110 (or payment service provider (PSP)), each coupled to (and in communication with) one or more communication networks (or network connections) (as indicated, generally, by the arrowed lines). The one or more networks may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, the networks may include multiple different networks, such as a private payment transaction network made accessible by the networks 106a-c to the institutions 104 and 108 and the service provider 110, and, separately, the public Internet, which is accessible as desired to the first party 102, the networks 106a-c, the institutions 104 and 108, the service provider 110, and a communication device 112 associated with a user 114, etc.

The first party 102 in the system 100 is generally a merchant, in this embodiment, and is associated with products (e.g., goods and/or services, etc.) offered for sale and sold to consumers, including the user 114. In the illustrated embodiment, the first party 102 is or includes a virtual location 116 (e.g., a website, a network-based application, etc.), whereby products are offered for sale and sold through one or more interfaces displayed to the user 114 at the virtual location 116 and to other consumers remote from the first party's physical location, etc. In such examples, the user 114, for instance, is permitted (e.g., via the communication device 112, another computing device, etc.) to browse product(s) through the one or more interfaces associated with the virtual location 116, and to add products to a “shopping cart,” and checkout to purchase the products from the first party 102 (all via the first party's virtual location 116). It should be appreciated that when the virtual location 116 includes a website, the website (and one or more interfaces associated therewith) are displayed to the user 114, for example, through a web browser 118 at the communication device 112. The web browser 118 may include, for example, the Chrome® browser, the Safari® browser, the Firefox® browser, etc.

The banking institutions 104 and 108 are both banks or other financial institutions which issue and maintain accounts for users, including the first party 102 and the user 114. The accounts may include any different types of financial accounts, including credit accounts, savings accounts, checking accounts, debit accounts, prepaid accounts, etc. What's more, in FIG. 1, the banking institution 108, as an issuing bank (e.g., an issuer of accounts, etc.), may include multiple different banking institutions within the scope of the present disclosure, wherein each issues accounts which are associated with one of the networks 106a-c.

In the system 100, the first party 102 has agreed and/or contracted with the service provider 110 to provide payment services in connection with the virtual location 116 (e.g., as a secure remote payment initiator, or secure remote initiator, etc.). As such, the service provider 110 is configured to integrate into and/or communicate with the virtual location 116, whereby the user 114 and other consumers are permitted to utilize remote payment options through the service provider 110 to facilitate purchases of products, etc., from the first party 102 and which purchases are then to be funded by the consumers' payment accounts. The service provider 110 may include, for example, PayPal®, Stripe®, other providers, etc. That said, it should be appreciated that other first parties, especially first parties with certain levels of resources and/or transactions, may act as their own service providers, whereby the service providers would not be separate from the first parties and whereby operations attributed herein to the service provider 110 would be included in a backend computing device associated with the first parties and/or virtual locations associated therewith.

The user 114 in the system 100 is associated with two different payment accounts, which are both issued to the user 114 by the banking institution 108 in this embodiment. One of the payment accounts (e.g., PA1, etc.) is specific to the payment network 106a, and the other payment account (e.g., PA2, etc.) is specific to payment network 106b, whereby transactions performed to the payment accounts are passed through the respective ones of the payment networks (i.e., through the payment network associated with the given payment account). It should be appreciated that the user 114 may also be associated with one or more other payment accounts issued by the banking institution 108 or by another institution or issuers (not shown), and which are specific to the payment network 106c or to other payment networks.

As it relates to the system 100, the user 114, in general, will use one of the payment accounts PA1 and PA2 to fund purchases of products at the virtual location 116 of the first party 102.

Each of the payment networks 106a-c in the system 100 is configured to facilitate payment account transactions between users and the first party 102, for transactions that involve payment accounts associated with the particular one of the payment networks 106a-c. In general, each of the payment networks 106a-c is configured to coordinate messaging between acquiring banking institutions (e.g., banking institution 104, etc., in the system 100) (associated with first parties such as the first party 102 or other merchants) and issuing banking institutions (e.g., banking institution 108, etc., in the system 100) (associated with consumers, such as the user 114), to provide authorization, clearing and settlement for the transactions. In addition, in this exemplary embodiment, each of the payment networks 106a-c is configured to store payment account credentials for the consumers' payment accounts, which are made accessible to the service provider 110 in connection with remote payment at, for example, the virtual location 116 of the first party 102.

In connection with the above, the payment networks 106a-c are each configured to provide EMV® Secure Remote Commerce (SRC) services, as described, for example, in the EMV® Secure Remote Commerce Specification, issued by the EMVCo™, which is incorporated herein by reference. As part thereof, the payment networks 106a-c include digital card facilitators (DCFs) 120a-c, respectfully. Each of the DCFs 120a-c is configured to perform as described herein. In particular, for example, the DCFs 120a-c are each configured to provide users with access to payment accounts (e.g., digital credentials associated therewith, etc.) and billing addresses and/or shipping addresses to facilitate checkout in connection with the corresponding payment networks 106a-c.

That said, in the illustrated embodiment, each of the payment networks 106a-c is configured to expose a corresponding one of application programming interfaces (APIs) 122a-c to the service provider 110 (as indicated by the dotted lines in FIG. 1). The APIs 122a-c, for example, each include: a payload call, whereby a payload related to a transaction and payment account is requested; a confirmation call, whereby a confirmation of a transaction is requested; and a registration call, whereby a user is registered with the respective one of the payment networks 106a-c. As each of the APIs 122a-c is generated and exposed by different ones of the payment networks 106a-c, each is generally different in type, format, and/or protocol from the other ones of the APIs 122a-c (although such differences are not necessary or required in all embodiments). In addition to the APIs 122a-c, the payment networks 106a-c also each include a corresponding one of software development kits (SDKs) 124a-c, whereby (or through which) client side content is delivered from the payment networks 106a-c to the service provider 110. As with the APIs 122a-c, the SDKs 124a-c each provide a different type, format, and/or protocol from the other ones of the SDKs 124a-c (although, again, such differences are not necessary or required in all embodiments).

The service provider 110 in the system 100 includes a secure remote commerce initiator (SRCi) 126 (e.g., as a payment interface, etc.) and three SDKs 128-132 (SDK-1, SDK-2, and SDK-3 in FIG. 1). The SRCi 126 is configured to provide an interface between the virtual location 116 and the SDKs 128-132 on service side interactions (e.g., by way of the SDK 128) (as indicated by the top dotted circle 134 in FIG. 1) and on client side interactions (e.g., by way of SDKs 130 and 132) (as indicated by the bottom dotted circle 136 in FIG. 1).

In this exemplary embodiment, the SDK 128 is associated with the APIs 122a-c to provide interaction therewith for routing and messaging associated with transactions, and the SDKs 130 and 132 are associated with the SDKs 124a-c to provide interactions therewith for user interfaces and resources associated with the SRCi 126. The SDK 132 consolidates the functions of the SDKs 124a-c, such as card enrollment, one time password (OTP) operations, identity lookup, get user profile operations, and checkout, and exposes one common method for each functionality to the service provider 110. In this manner, the SDK 132 acts as a gateway and a router between SRCi 126 and SDKs 124a-c. The SDK 130 is configured to provide one or more SRCi user interfaces (UIs) to the user 114, via the SRCi 126. The SDK 130 is generally integrated with or in communication with the SDK 132 in order to communicate with the SDKs 124a-c, as explained in detail below. The SDK 130 also includes a load function in order to ease the integration with the SRCi 126. In addition, the interfaces associated with the SDK 130 may be customizable, whereby the service provider 110 is permitted to modify the interfaces included in the SDK 130 to, for example, emulate the color scheme, headers, etc., of the virtual location 116, whereby the user 114 would understand the interfaces to be an extension of the virtual location 116 and not separate therefrom. That said, the SDK 130 is optional herein, in that the SDK 130 may be omitted where the service provider 110 builds and integrates interfaces into the SRCi 126, as compared to relying on the SDK 130 for interfaces associated with the remote payment services.

It should be appreciated that the SDKs 128-132 are included together, as indicated by the box 138 encompassing the SDKs 128-132, whereby the SDKs 128-132 are provided together to the service provider 110 as an integrated package (e.g., package 138) to be integrated with the SRCi 126 (and configured to communicate therewith on both the service side (at 134) and the client side (at 136)). In this manner, the service provider 110 is tasked with interacting with the SDK 128 for service side interactions and with the SDK 130 for client side interactions. In other exemplary embodiments, as mentioned above, only the SDK 128 and SDK 132 may be packed together (with the SDK 130 omitted) and provided to a service provider as a package for integration, where the service provider includes one or more interfaces to present to the user 114, for example, for client side interactions directly with the SDKs 124a-c.

It should be understood that each of the SRCi 126 and the SDKs 128-132 are hosted in the service provider 110 (e.g., at the computing device 200 illustrated as part of the service provider 110, etc.) and each includes executable instructions, which are included in the virtual location 116 of the first party 102 and, therefore, are executable at the user's communication device 112 (and in particular, at the web browser 118 thereof) in connection with remote payments by the user 114 at the virtual location 116.

In view of the above, when the user 114 seeks to checkout at the virtual location 116 of the first party 102 (and fund the purchase of one or more products through his/her payment account (PA1) associated with the payment network 106a), the communication device 112, as configured by the SRCi 126 (when executed or run by the web browser 118), provides one or more different interfaces to support the checkout process. In general, the interfaces, and rules associated with the interfaces, are provided by the SRCi 126 calling the SDK 130, which, in turn, calls the SDK 132. The SDKs 130 and 132 then cooperate to identify the particular ones of the networks 106a-c to which the checkout request will be sent (i.e., the network 106a in the above example), and to cause a request, from the SRCi 126, to be mapped (or translated) and/or provided to the SDK 124a in the particular type, format, and protocol of the SDK 124a associated with the payment network 106a (for example, as compared to the potentially different type, format, and protocol required by either the SDK 124b associated with the payment network 106b or the SDK 124c associated with the payment network 106c). This may include, for example, mapping the received data (for the given transaction as identified in the request) based on one or more correlation tables stored in memory, such as, for example, the segment of the exemplary correlation table provided in Table 1. It should be appreciated that mapping may be omitted in various embodiments, depending on the particular SDKs and/or APIs involved. The interfaces and rules are then imposed on the interaction between the user 114 and the service provider 110, via the SRCi 126 of the virtual location 116, to facilitate remote payment.

TABLE 1

| | SDK 124a | SDK 124b | SDK 124c |
|---|---|---|---|
| . . . | . . . | . . . | . . . |
| User Last Name | lastname | maskedlastname | . . . |
| User Identity Identifier | identityidentifier | identityid | . . . |
| Mobile Phone Number | mobilephoneno | N/A | . . . |
| . . . | . . . | . . . | . . . |

It should be appreciated that the interfaces and/or rules described above may be implemented to solicit receipt of complete information from the user 114 (as potentially required by the identified one of the payment networks 106a-c), whereby some of the received data may be used for interactions with different ones of the networks 106a-c but not others. For example, an interface may solicit a mobile phone number from the user 114, but may not include the mobile phone number in a request to the network 106b, because the SDK 124b does not solicit that information (as shown in Table 1) (as compared to the network 106a).

When the user 114 provides the necessary data in response to the interfaces caused by the SRCi 126, and potentially, authenticates himself/herself to the communication device 112, the SRCi 126 configures the communication device 112, via the SDK 128, to send a request to the payment network 106a, via the API 122a, to request a payload (e.g., payment account information for PA1 associated with the user 114, etc.). In particular, the request is provided initially to the SDK 128 of the service provider 110, which identifies the particular ones of the networks 106a-c to which the request is to be sent (i.e., network 106a in the above example) (e.g., based on an SRC profile, etc.), and maps the request to be consistent with the particular type, format, and protocol required by the API 122a, exposed by the payment network 106a (because the PA1 is associated with the payment network 106a) (for example, as compared to the potentially different type, format, and protocol required by either the API 122b associated with the payment network 106b or the API 122c associated with the payment network 106c). It should be appreciated that the mapping may, in various embodiments, again be based on a correlation table, such as shown in Table 1. The call is made, via the communication device 112, by the SDK 128 to the API 122a, whereupon a payload (having payment account information for PA1) is returned from the API 122a, and passed, by the SDK 128 to the SRCi 126, after being mapped back into a type, format and/or protocol known to the service provider 110.

Thereafter, the service provider 110 is configured to initiate a payment account transaction for the underlying purchase by the user 114. In particular, the service provider 110 is configured to compile and transmit an authorization request for the transaction to the banking institution 104 (as associated with the first party 102), which in turn is configured to pass the authorization request to the banking institution 108, via the payment network 106a. The banking institution 108 is configured to approve or decline the transaction based, at least in part, on the information included in the authorization request and to compile and transmit an authorization reply back to the service provider 110 through the payment network 106a and the banking institution 104. Thereafter, when the transaction is approved, the first party 102 is notified (e.g., by the service provider 110, by the banking institution 104, etc.) and arranges for delivery of the product(s) purchased to the user 114.

It should be appreciated that, more generally in the system 100, the SDKs 128-132 cooperate to abstract communication from the SRCi 126 to the networks 106a-c, and specifically, the APIs 122a-c and the SDKs 124a-c, respectively, in order to provide communication therebetween, while limiting necessary development and/or revision to the SRCi 126. It should further be appreciated that while the operation of the SDKs 128-132 is described with reference to the payment network 106a, the same or similar operations would be applicable for a payment account associated with the payment network 106b or the payment network 106c, whereby the SDKs 128 and 132 would interact with the appropriate ones of the SDKs 124b-c and/or the APIs 122b-c in the manner described above or similar thereto.

While one first party 102, two banking institutions 104 and 108, three payment networks 106a-c, one service provider 110, one user 114, and one communication device 112 are illustrated as included in the system 100, it should be appreciated that any number of these entities and/or persons (and their associated components) may be included in the system 100, or may be included as a part of systems in other embodiments, consistent with the present disclosure.

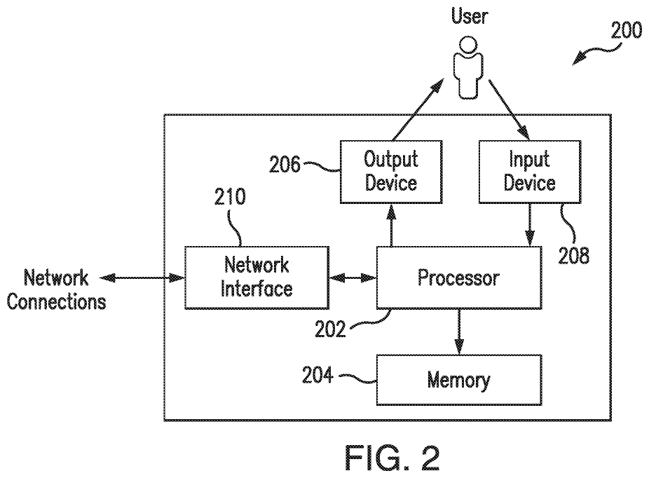

FIG. 2 illustrates an exemplary computing device 200 that can be used in the system 100. The computing device 200 may include, for example, one or more servers, workstations, personal computers, laptops, tablets, smartphones, PDAs, POS devices, etc. In addition, the computing device 200 may include a single computing device, or it may include multiple computing devices located in close proximity or distributed over a geographic region, so long as the computing devices are specifically configured to function as described herein. In particular, in the exemplary system 100 of FIG. 1, each of the first party 102, the banking institutions 104 and 108, the payment networks 106a-c, and the service provider 110 are illustrated as including, or being implemented in, computing device 200, coupled to one or more of the communication networks in the system 100. In addition, the communication device 112 associated with the user 114 may be considered a computing device consistent with the computing device 200. That said, however, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data; definitions of API formats, types and/or protocols; SDKs; and/or other types of data (and/or data structures) suitable for use as described herein. Furthermore, in various embodiments, computer-executable instructions may be stored in the memory 204 for execution by the processor 202 to cause the processor 202 to perform one or more of the functions described herein (e.g., one or more of the operations of method 300, etc.), such that the memory 204 is a physical, tangible, and non-transitory computer readable storage media. Such instructions often improve the efficiencies and/or performance of the processor 202 that is performing one or more of the various operations herein (e.g., the performance of the communication device 112, the computing devices 200 at the various parts of the system 100, etc.). It should be appreciated that the memory 204 may include a variety of different memories, each implemented in one or more of the functions or processes described herein.

In addition in the exemplary embodiment, the computing device 200 includes an output device 206 that is coupled to (and is in communication with) the processor 202. The output device 206 outputs information (e.g., remembered payment account options, etc.), either visually or audibly, to a user of the computing device 200, for example, the user 114, users associated with other parts of the system 100, etc. Various interfaces may also be displayed at computing device 200, and in particular at output device 206, to display such information. The output device 206 may include, without limitation, a presentation unit such as a liquid crystal display (LCD), a light-emitting diode (LED) display, an organic LED (OLED) display, an “electronic ink” display; speakers; another computer; etc. In some embodiments, the output device 206 may include multiple devices.

The computing device 200 also includes an input device 208 that receives inputs from the user 114 of the computing device 200 (i.e., user inputs) such as, for example, selections of SRC pay options, identifying information, user IDs, etc. The input device 208 is coupled to (and is in communication with) the processor 202 and may include, for example, a keyboard, a pointing device, a mouse, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, may behave as both the output device 206 and the input device 208.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to/with one or more different networks, for example, in the system 100, etc. Further, in some exemplary embodiments, the computing device 200 may include the processor 202 and one or more network interfaces (including the network interface 210) incorporated into or with the processor 202.

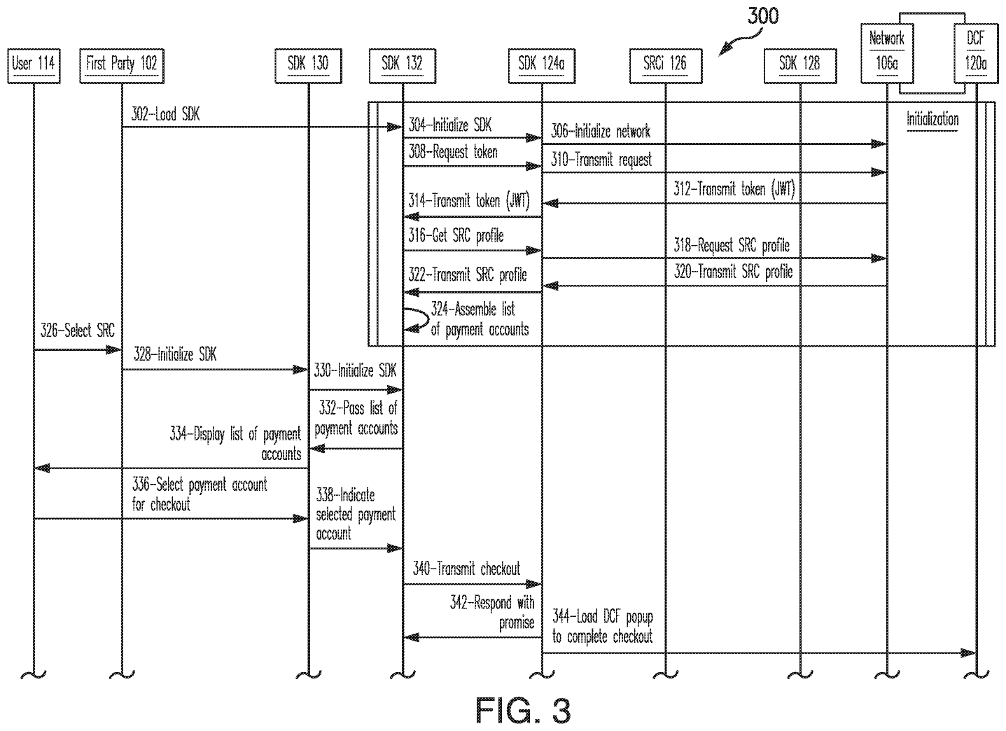

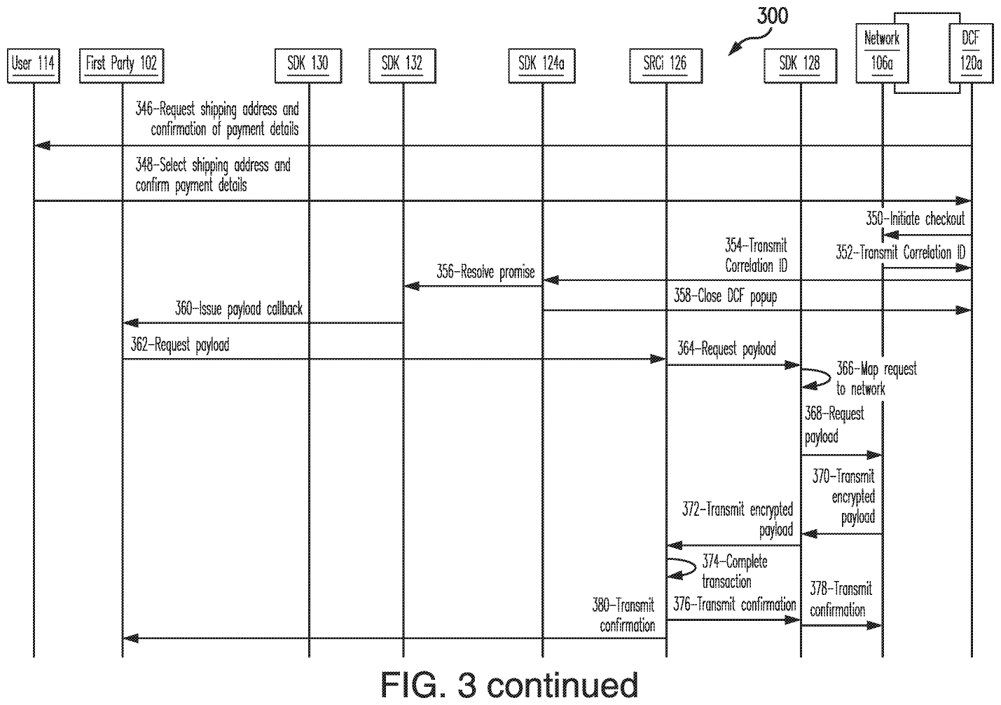

FIG. 3 illustrates an exemplary method 300 for use in facilitating transactions, by one or more consumers, at a virtual location associated with a first party. The exemplary method 300 is described with reference to the system 100 of FIG. 1. Further reference is also made to the computing device 200. However, it should be understood that the method 300 (and other methods herein) are not limited to the system 100 or the computing device 200, as the method 300, for example, may be implemented, at least in part, in other parts of suitable systems, or in multiple other computing devices or systems. Likewise, the systems and the computing devices herein (including the system 100 and the computing device 200) should not be understood to be limited to the exemplary method 300.

In the exemplary method 300, it is assumed that the user 114 is a recognized user and has previously interacted with the first party 102, via the virtual location 116, and has decided to purchase one or more products from the first party 102. In connection therewith, the user 114 has added the products to be purchased to a virtual shopping cart at the virtual location 116, has selected to checkout, and, via an interface from the SRCi 126, has selected to do so using the remote commerce service.

As such, at 302, the first party 102 (or the virtual location 116) loads the SDK 132 (i.e., the client side SDK at the service provider 110 (which includes, among other things, a UI integrator (e.g., for the SDK 130 and/or the service provider's' interfaces, etc.), business logic, and routing logic, etc.)) (and also loads SDKs 128 and 130, as necessary), whereupon the SDK 132 performs an initialization sub process, as indicated by the block in FIG. 3.

In particular in the initialization sub process, the SDK 132 initializes, at 304, the SDK 124a, which may include providing a SRC initialization ID, a SRCi transaction ID, a SRCi DPA ID, and transaction options. The SDK 124a, in turn, initializes the network 106a, at 306. In addition, the SDK 132 requests a token for the user 114, at 308, whereby the user 114 will be a recognized user. The request is provided from the SDK 124a to the network 106a, at 310. The network 106a responds by transmitting, at 312, the token (e.g., a JSON web token (JWT), etc.) to the SDK 124a, which is transmitted, by the SDK 124a, at 314, to the SDK 132. The token includes user information for the user 114, such as, for example, an email address, a device ID for the user's communication device 112, etc., that can be recognized from all of the payment networks 106a-c and be used to fetch payment account details for the user 114 therefrom (e.g., the token is a federated token and can be recognized by all of the payment networks 106a-c and used to retrieve payment account details for the user 114 from each of the payment networks 106a-c, etc.).

In connection therewith, the SDK 132 sends, at 316, a get SRC profile request to the SDK 124a for the user 114. The request includes the token received from the network 106a. In response, the SDK 124a requests, at 318, the user's SRC profile (again including the token in the request) from the network 106a. The network 106a retrieves the SRC profile for the user 114, based on, at least in part, the token, and transmits, at 320, the SRC profile to the SDK 124a. The SRC profile includes, for example, different payment accounts registered with the network 106a for the user 114, etc. (e.g., PA1, PA2, etc.). In turn, the SDK 124a transmits, at 322, the SRC profile to the SDK 132.

While steps 304-322 are described with reference to the SDK 124a and the network 106a, it should be appreciated that the SDK 132 will repeat and/or duplicate these steps for each other SDK and/or network, as appropriate. For instance, with reference to FIG. 1, then, the SDK 132 will repeat steps 304-322 for the SDK 124b and network 106b and also the SDK 124c and the network 106c (whereby the initialization sub process is performed with regard to each of the networks 106a-c). Finally in the sub process, when the SRC profile is received from the network 106a (and/or from the networks 106b-c, when appropriate), the SDK 132 assembles, at 324, a listing of available payment accounts associated with the network 106a (and networks 106b-c) for the user 114. In addition, the SDK 132 includes a network scheme identifier for each of the payment accounts in a profile for the user 114 and/or the assembled list of payment account, where the identifier is indicative of one of the networks 106a-c associated therewith, thereby permitting the SDKs 128 and 132 to identify the particular network scheme and/or network in connection with the interactions described above. The network scheme identifier may be determined, for each payment account, based on a BIN included in the PAN for the payment account (e.g., 5524 for Mastercard®, etc.).

At this point, checkout via SRC is initiated by the user 114 selecting, at 326, the option to pay with SRC (e.g., at a payment page of the virtual location 116 through the user's communication device 112 or other computing device through which the user 114 accesses the virtual location 116, etc.). In response, the virtual location 116 of the first party 102 (i.e., the payment page) initializes the SDK 130, at 328, and the SDK 130 in turn initializes, at 330, the SDK 132 (e.g., the SDK 130 handles the SRC trigger automatically and calls an “openSRCi” function of the SDK 132, etc.), whereby an SRCi UI is displayed to the user 114. It should be appreciated that the SRCi UI may be based on one or more templates available from the SDK 130, whereupon the SDK 130 interacts with the SDK 132 to display the SRCi UI to the user 114. Alternatively, or additionally, the SRCi 126 may be involved to display the SRCi UI to the user 114, for example, where the SDK 130 is omitted. The SDK 132 further passes, at 332, the assembled list of payment accounts to the SRCi UI (e.g., at the SDK 130, etc.), whereupon the list of payment accounts is displayed, at 334, to the user 114 in the SRCi UI.

The user 114, in turn, selects, at 336, one of the payment accounts for use in the transaction, such as, for example, PA1, in the SRCi UI, whereby the selection is received by the SDK 130. Then, at 338, the SDK 130 indicates the selected payment account, for example, PA1, to the SDK 132.

With the payment account selected, the SDK 132 initiates checkout, at 340, with the SDK 124a (based on the selected payment account PA1, in this example, being associated with the network 106a), by identifying the network 106a (based on the selected account, PA1) (e.g., from the SRC profile and/or the assembled list of accounts, etc.), and passing a checkout request and payment account details (e.g., masked payment account details, etc.) to the SDK 124a (e.g., a SRC digital card ID of the selected account (i.e., PA1), etc.) along with transaction options (e.g., a transaction amount, a payment account identifier, a type of encryption for the payload, etc.) and a window reference (i.e., to permit control of the interface window (e.g., for displaying the SRCi UI, etc.)). It should be appreciated that the request may be modified (e.g., mapped, etc.) based on the particular requirements of the SDK 124a. The SDK 124a, in turn, responds with a promise for the transaction (e.g., an indicator that a correlation ID is requested, etc.), at 342, and further loads, at 344, the DCF 120a (as a DCF popup, etc.) to complete the checkout. The DCF popup includes the card ID for the selected payment account (e.g., PA1, etc.) and one or more transaction settings for the transaction (as received from the SDK 132).

Thereafter, the DCF 120a requests, at 346, for example, a shipping address and a confirmation of payment details (e.g., an ID associated with PA1, a transaction amount, a merchant ID for the first party 102, etc.) from the user 114 (at the communication device 112) (via the DCF popup). At 348, the user 114 responds by selecting (or entering) a shipping address and confirming the payment details (via the DCF popup). The DCF 120a, in turn, initiates checkout, at 350, with the payment network 106a. In response, the payment network 106a generates and transmits, at 352, a correlation ID to the DCF 120a, and the DCF 120a transmits, at 354, the correlation ID to the SDK 124a. The SDK 124a then returns the correlation ID to the SDK 132 thereby resolving the promise with the SDK 132 by providing the correlation ID, at 356. And, the SDK 124a closes the DCF popup, at 358.

Next in the method 300, the SDK 132 issues a payload callback, at 360, to the first party 102. The callback includes the correlation ID from the payment network 106a and an indication of the payment network 106a (e.g., a “network scheme” or network code for the payment network 106a such as Mastercard, VISA, AMEX, etc.) The first party 102, in turn, transmits a request for a payload, at 362, based on the correlation ID and network indication, to the SRCi 126. The SRCi 126 then requests the payload from the payment network 106a, which is specific to the payment account selected by the user 114 (e.g., PA1, etc.). In particular in this example, the SRCi 126 issues a request to the SDK 128, at 364, which identifies the network 106a (based on a network scheme identifier and/or a payment account number for the selected payment account, PA1), and maps, at 366, the request from the format provided from the SRCi 126 into a format specific to the payment network 106a. For example, the SDK 128 is informed about a naming convention for the API 122a, the header, and the method and data requirements of the API 122a, whereby the SDK 128 maps the data, for example, the last name of the user 114, into the API call in the specific data location required by the API 122a (e.g., from “lastname” into “maskedlastname”, etc.). It should be appreciated that the different APIs 122a-c may request more or less data in processing a transaction than other ones of the APIs, whereby in mapping the request, the SDK 128 includes the necessary and/or requested data for the given one of the APIs 122a-c (in the format specific to the corresponding one of the networks 106a-c) in the call to the respective one of the APIs 122a-c. As needed, the SDK 128 may also request additional information from the user 114 (via one or more user interfaces) to ensure that such necessary information is included in the call to the particular ones of the APIs 122a-c.

Then, the SDK 128 initiates an API call 122a to the payment network 106a, at 368, requesting the payload. The payment network 106a responds to the API call, at 370, by transmitting an encrypted payload to the SDK 128. And, the SDK 128 transmits, at 372, the encrypted payload to the SRCi 126.

The SRCi 126 then decrypts the payload (based on an exception key held by the SRCi 126) and completes, at 374, the transaction by communicating with the institutions 104 and 108, via the payment network 106a. In particular, with the payload (including payment account information), the SRCi 126 of the service provider 110 compiles and transmits an authorization request for the transaction to the banking institution 104 (e.g., as an acquirer for the first party 102, etc.). The authorization request is passed from the banking institution 104 to the payment network 106a, and then the authorization request is passed from the payment network 106a to the banking institution 108. The banking institution 108, which is the issuer of selected payment account PA1 in this example, then determines whether to approve or decline the transaction. Thereafter, the banking institution 108 compiles and transmits an authorization reply for the transaction to the payment network 106a. The authorization reply is passed from the payment network 106a to the banking institution 104, and then the authorization reply is passed from the banking institution 104 to the SRCi 126. When the transaction is approved, the SRCi 126 transmits a confirmation, at 376, to the SDK 128, which in turn identifies the payment network 106a (as described above), and maps, as necessary, the confirmation into a confirmation call to the API 122a of the payment network 106a, at 378. Additionally, the SRCi 126 transmits, at 380, a confirmation to the first party 102.

While method 300 in general is described with reference to the network 106a, the DCF 120a, the API 122a, and the SDK 124a, such description is based on a selection of the payment account PA1, which is specific to the network 106a. If, instead, the user 114 had selected a payment account associated with the network 106b or the network 106c, the steps above would be the same (i.e., via the SDK 128-132) (or SDK 128 and SDK 132, when SDK 130 is omitted), except directed to the DCF 120b, the API 122b, and the SDK 124b of the payment network 106b or directed to the DCF 120c, the API 122c, and the SDK 124c of payment network 106c, but with different mapping, for example, specific to the type, format, and protocol of the respective networks 106b or networks 106c. This, in short, provides the integration advancement for the service provider 110, where the integration with the package 138 of SDKs 128-132 (or with the SDKs 128 and 132) provide integration with multiple different networks 106a-c with common interaction points (i.e., the circles 134 and 136 in FIG. 1) and the types, formats and protocols of the interaction are the same regardless of the networks 106a-c.

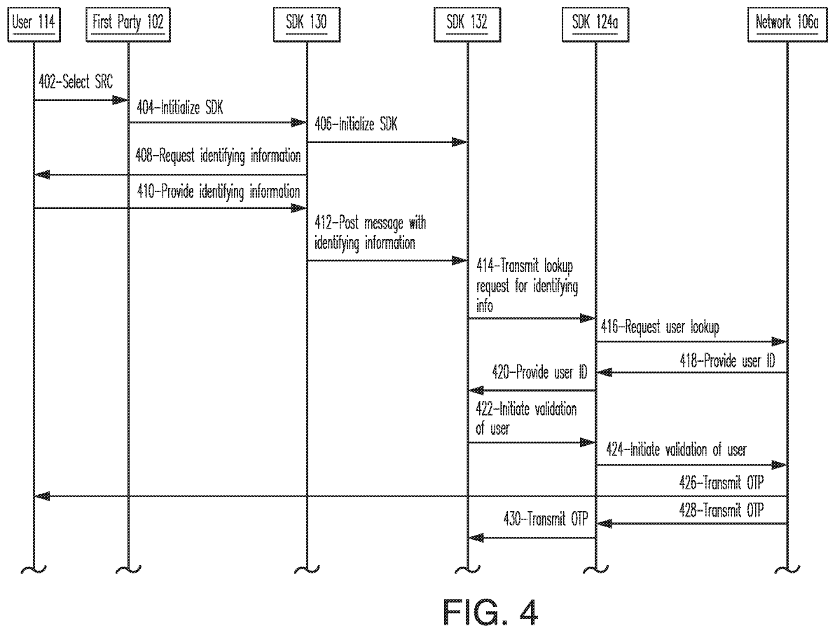

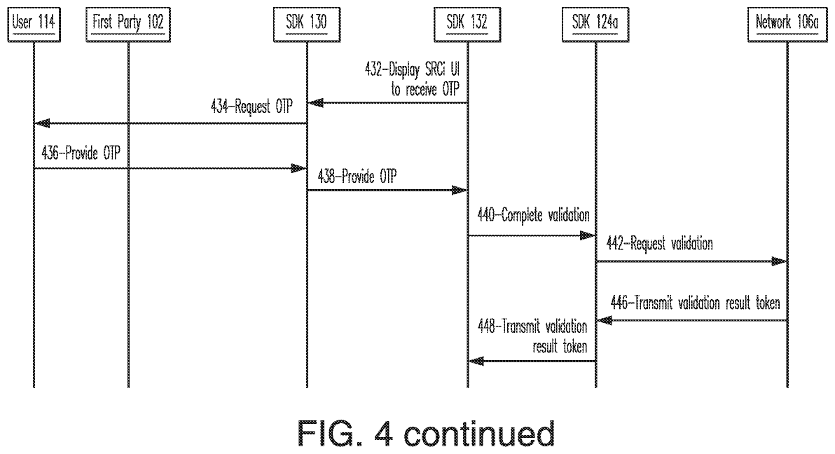

FIG. 4 illustrates an exemplary method 400 for use in facilitating transactions, by one or more consumers, at a virtual location associated with a first party. The exemplary method 400 is described with reference to the system 100 of FIG. 1. Further reference is also made to the computing device 200. However, it should be understood that the method 400 (and other methods herein) are not limited to the system 100 or the computing device 200, as the method 400, for example, may be implemented, at least in part, in other parts of suitable systems, or in multiple other computing devices or systems. Likewise, the systems and the computing devices herein (including the system 100 and the computing device 200) should not be understood to be limited to the exemplary method 400.

In the exemplary method 400, it is assumed that the user 114 is an existing user with regard to the first party 102, but is not a recognized user. It is further assumed that the user 114 has interacted with the first party 102, via the virtual location 116, and has decided to purchase one or more products from the first party 102 (through the virtual location 116). In connection therewith, the user 114 has added the products to be purchased to a virtual shopping cart at the virtual location 116 and selected to checkout. In response, the first party 102 initializes the SDKs 124a-c, which in turn, initialize the networks 106a-c as done in the method 300 of FIG. 3. In the method 400, however, the user 114 is not recognized through this process, whereby a SRC profile is not received by the SDK 132 from the networks 106a-c (such that a list of payment accounts for the user 114 is not assembled).

As such, in the method 400, in response to the user selecting SRC for checkout, at 402, the virtual location 116 of the first party 102 (i.e., the payment page) initializes the SDK 130, at 404, and the SDK 130 in turn initializes, at 406, the SDK 132 (e.g., the SDK 130 handles the SRC trigger automatically and calls an “openSRCi” function of the SDK 132, etc.), whereby an SRCi UI is displayed to the user 114. It should be appreciated that the SRCi UI may be based on one or more templates available from the SDK 130, whereupon the SDK 130 interacts with the SDK 132 to open the SRCi UI for the user 114. As above, alternatively, or additionally, the SRCi 126 may be involved to display the SRCi UI to the user 114, for example, where the SDK 130 is omitted. In the method 400, as indicated above, the version of the SRCi UI displayed to the user 114 is for an unrecognized user.

When the SRCi UI is displayed to the user 114, at the communication device 112, the SDK 130, via the SRCi UI, requests, at 408, user identifying information from the user 114, such as, for example, an email address, a phone number, etc. In response, the user 114 provides, at 410, user identifying information (e.g., the requested email address, phone number, etc.) to the SDK 130, via the SRCi UI. The SDK 130 then posts a message, at 412, to the SDK 132 with the user's identifying information in order to identify the user 114. The SDK 132 transmits, at 414, a lookup request to the SDK 124a, which in turn requests, at 416, a user lookup from the payment network 106a (which includes the identifying information). That said, while the lookup request is only transmitted to the SDK 124a and the payment network 106a in this example, it should be appreciated that the lookup request would be transmitted to all SDKs and networks associated with the SDK 132 in other implementations, including, in the context of FIG. 1, to the SDKs 124b-c and the payment networks 106b-c. In any case, the payment network 106a (in this example) responds to the request and provides, at 418, a user ID for the user 114. At 420, the user ID is provided by the SDK 124a to the SDK 132. It should be appreciated that when a lookup request is directed to all three network 106a-c, the SDK 132 will proceed when the first of the networks 106a-c responds.

Upon receipt of the user ID, the SDK 132 initiates, at 422, a request for validation of the user 114 (i.e., to recognize the user 114), with the SDK 124a. The validation request generally includes the user ID (which may include an email address or phone number for the user 114, etc.). Unlike the lookup described above, the SDK 132, in this exemplary embodiment, only initiates the validation with the payment network 106a (but that may be otherwise in other embodiments). As such, in turn, the SDK 124a initiates, at 424, a validation of the user 114 with the payment network 106a (which includes a request to the payment network 106a including the user ID for the user 114). The payment network 106a then transmits, at 426, a one-time passcode (OTP) to the user 114 at the communication device 112 (e.g., as an email or SMS message based on the email address or phone number for the user 114 associated with the user ID, or otherwise, etc.). In addition, the payment network 106a transmits, at 428, the OTP to the SDK 124a, which in turn provides the OTP, at 430, to the SDK 132 (for use in subsequent validation of the OTP sent to the user 114).

The SDK 132 then displays the SRCi UI, at 432, to collect the OTP from the user 114. As such, the SRCi UI requests, at 434, the OTP from the user 114. When the user 114 provides the OTP (at the communication device 112), at 436, the SRCi UI provides the OTP from the user 114 to the SDK 132 at 438. The SDK 132 then provides the OTP received from the user 114 to the SDK 124a to complete validation of the user 114, at 440.

In connection with completing validation of the user 114, the SDK 124a requests, at 442, validation of the OTP received from the user 114 by the network 106a. The payment network 106a compares the received OTP to the OTP initially transmitted, by the network 106a, to the user 114, and completes the validation. The payment network 106a then transmits, at 446, a validation result token to the SDK 124a. In turn, the SDK 124a passes, at 448, the validation result token to the SDK 132 (which may or may not include payment account information, user information for the user 114 (e.g., an email address, a device ID for the user's communication device 112, etc.). Alternatively, when the validation is unsuccessful, the SRCi UI displays a failed validation message to the user 114 at the communication device 112, which permits the user 114 to try again or to continue as a guest for checkout with the first party 102. Ultimately, when the validation is successful, the user 114 is recognized whereby the method 300 may be pursued by the user 114 and/or the first party 102 to proceed with checkout (e.g., as described with reference to FIG. 3; etc.).

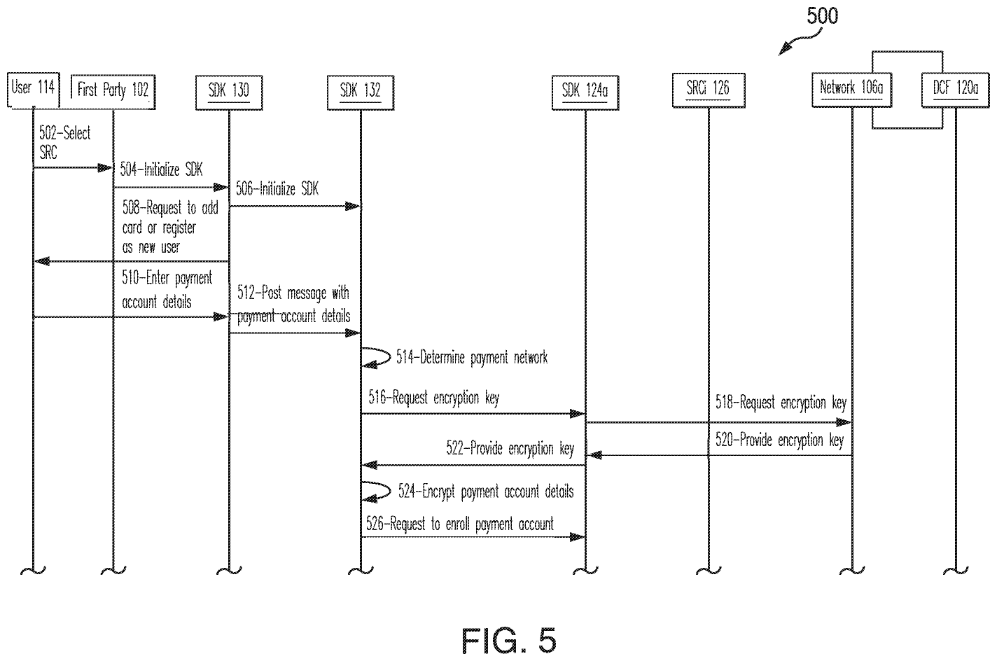

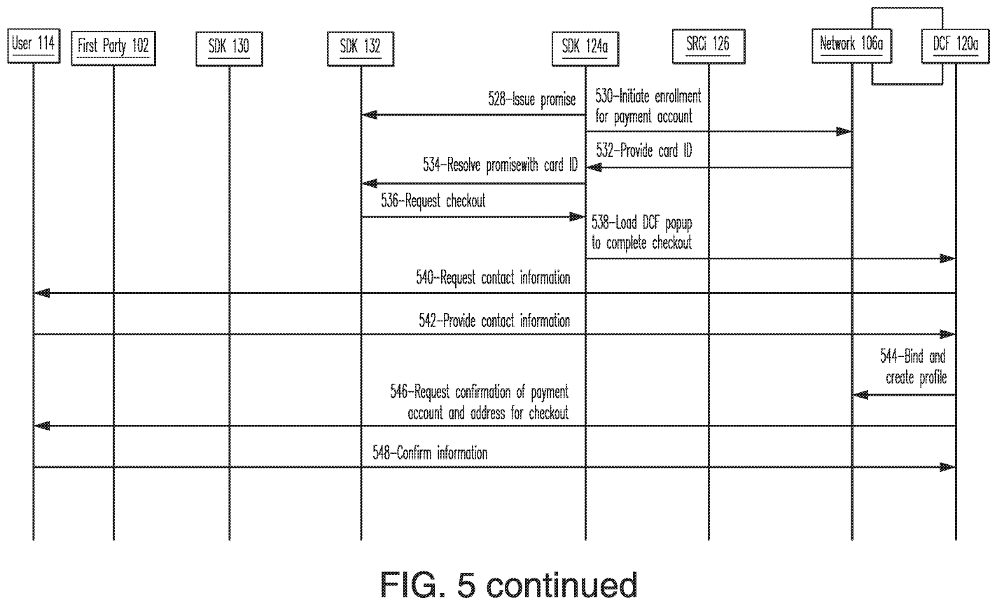

FIG. 5 illustrates an exemplary method 500 for use in facilitating transactions, by one or more consumers, at a virtual location associated with a first party. The exemplary method 500 is described with reference to the system 100 of FIG. 1. Further reference is also made to the computing device 200. However, it should be understood that the method 500 (and other methods herein) are not limited to the system 100 or the computing device 200, as the method 500, for example, may be implemented, at least in part, in other parts of suitable systems, or in multiple other computing devices or systems. Likewise, the systems and the computing devices herein (including the system 100 and the computing device 200) should not be understood to be limited to the exemplary method 500.

In the exemplary method 500, it is assumed that the user 114 is neither an existing user nor a recognized user of the first party 102, but has now interacted with the first party 102, via the virtual location 116, and has decided to purchase one or more products from the first party 102. In connection therewith, the user 114 has added the products to be purchased to a virtual shopping cart at the virtual location 116 of the first party 102 and selected to checkout. In response, the first party 102 attempts to initialize the SDKs 124a-c, which in turn attempt to initialize their corresponding networks 106a-c, as done in the method 300 of FIG. 3. In the method 500, however, the user 114 is not recognized during such initialization process, whereby a SRC profile is not received by the SDK 132 from the networks 106a-c (and a list of payment accounts for the user 114 is not assembled).

That said, the user 114 in turn still selects to fund the transaction through SRC, at 502. In response, the virtual location 116 of the first party 102 (i.e., the payment page) initializes the SDK 130, at 504, and the SDK 130 in turn initializes, at 506, the SDK 132, whereby an SRCi UI is displayed to the user 114.

In the method 500, as indicated above, the version of the SRCi UI displayed to the user 114 is for an non-existing, unrecognized user. As such, the SRCi UI displayed to the user 114, at the communication device 112, via the SDK 130, requests, at 508, for the user 114 to add a new card and/or register as a new user (i.e., via a card entry screen, etc.). In either case, the SRCi UI solicits user identifying information from the user 114, such as, for example, payment credentials associated with a payment account (e.g., a payment account number (PAN) for PA1 or PA2, etc.), etc. In response, the user 114 provides, at 510, payment account details (e.g., a PAN, an expiration date, a CVC code, a name, a billing address, etc.) to the SRCi UI. The SRCi UI then posts a message, at 512, to the SDK 132, which includes the user's payment account details. In response, the SDK 132 determines, at 514, which of the payment networks 106a-c is associated with the payment account provided by the user 114 (e.g., based on the PAN provided, etc.). In this exemplary embodiment, for example, the SDK 132 identifies the payment network 106a. As such, the SDK 132 requests, at 516, an encryption key from the SDK 124a, associated with the network 106a. And, the SDK 124a transmits, at 518, the request for the encryption key to the network 106a.

The payment network 106a responds to the request by providing, at 520, an encryption key to the SDK 124a. And, at 522, the SDK 124a provides the encryption key to the SDK 132.

At 524, the SDK 132 encrypts the user's payment account details, by using the encryption key received from the payment network 106a, and requests, at 526, for the SDK 124a to enroll the payment account for remote checkout. The SDK 124a, in turn, issues a promise to the SDK 132, at 528, whereby the SDK 132 is informed of the enrolment and/or data to be provided in connection with enrollment. Next, the SDK 124a initiates, at 530, enrollment for the user's identified payment account with the payment network 106a.

The payment network 106a, in turn, creates the card for the payment account in a data structure therein and provides a card ID for the payment account identified by the user 114, at 532, to the SDK 124a. The SDK 124a then resolves the promise for enrollment of the payment account with the SDK 132, at 534, by providing the card ID retrieved from the network 106a to the SDK 132. And, the SDK 132 requests, at 536, from the SDK 124a, checkout for the products included in the shopping cart of the user 114 at the first party 102. The SDK 124a, in turn, loads, at 538, a DCF popup (from the DCF 120a) to the user 114 at the communication device 112 to complete the checkout. The DCF popup includes the card ID for the selected payment account of the user 114 and transaction settings for checkout.

Thereafter, the DCF 120a requests (via the popup), at 540, from the user 114, contact information (e.g., billing address, shipping address, email address, and phone number, etc.) at the communication device 112. At 542, the user 114 responds by providing the requested contact information in the DCF popup, through the communication device 112. The DCF 120a, in turn, then binds and creates, at 544, a user profile for the user 114 with the payment network 106a, which includes, at the least, the card ID for the user's payment account and the contact information for the user 114. Thereafter, the DCF 120a requests, at 546, confirmation of the payment account (e.g., PA1, etc.) and the address for checkout from the user 114 (at the communication device 112). And, at 548, the user 114 confirms the payment account and address.

At this point in the method 500, the DCF 120a and other parts of system 100 proceed with checkout for the transaction, consistent with the operations beginning at step 350 in the method 300 and running through the remainder of the method 300 to complete checkout (e.g., because both method 300 and method 500 include transactions directed to payment account PA1 associated with the payment network 106a, etc.).

Again, while methods 400 and 500 in general are described with reference to the network 106a, this is based on a selection of the payment account PA1, which is specific to the network 106a. If, instead, the user 114 had selected a payment account associated with the payment network 106b or the payment network 106c, the steps above would be the same (i.e., via the SDK 128-132) (or SDK 128 and SDK 132, when SDK 130 is omitted), except directed to the DCF 120b, the API 122b, and the SDK 124b of the payment network 106b or directed to the DCF 120c, the API 122c, and the SDK 124c of payment network 106c, but with different mapping, for example, specific to the type, format, and protocol of the respective networks 106b or networks 106c.

In view of the above, the systems and methods herein permit consolidation of SDKs and/or APIs of different networks into a package of SDKs for hosted checkout, used by payment service providers. In particular, the integration of the package 138 of SDKs 128-132 (or with the SDKs 128 and 132) into the payment page of the virtual location of a merchant (either by the merchant or a payment service provider) enables integration with or between the payment page and multiple different networks 106a-c, yet with common interaction points (e.g., points 134 and 136 in FIG. 1, etc.). As such, the package coordinates identification of the network and the form of messaging so that the types, formats and protocols of the messaging from the service provider may be made consistent regardless of the associated networks. Consequently, an amount of technical integration effort for the service provider may be reduced (i.e., integration with an SDK and multiple APIs per network is reduced to integration with the package 138 of SDKs 128 and 132 (and SDK 130 for interfaces)). The reduction in integration efforts is compounded when the number of supported networks increases. This may further speed up the process of a service provider offering remote commerce solutions to merchants (or merchants offering remote commerce services themselves). What's more, when a change is implemented in one of the networks, the SDK publisher will modify the SDKs 128, 130, and/or 132 accordingly and republish the same. As such, for various different changes to the networks supported by the service provider, only integration of the SDKs 128-132 may be necessary, with little or no modification on the payment page (or SRCi) depending, for example, on a nature of the change to the network, etc. This may provide for reduction in the maintenance of the remote commerce service for the service provider.

Again, and as previously described, it should be appreciated that the functions described herein, in some embodiments, may be described in computer executable instructions stored on a computer readable media, and executable by one or more processors. The computer readable media is a non-transitory computer readable storage medium. By way of example, and without limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) compiling, by a computing device, a list of accounts for a user; (b) for each of the accounts, appending, by the computing device, a network scheme identifier to the account or to a profile for the user in association with the account, the network scheme identifier indicative of a network to which the account is associated; (c) receiving, at the computing device, a selection of one of the accounts from the list of accounts in connection with a checkout; (d) identifying, by the computing device, the network associated with the selected one of the accounts based on the network scheme identifier for the selected one of the accounts; (e) transmitting at least one message associated with the checkout to a software development kit (SDK) and/or an application programming interface (API) of the identified network, thereby allowing the identified network to process a network transaction in connection with the checkout; (f) receiving a payload request from a service provider in connection with the transaction; and (g) mapping the payload request into the at least one message in a type, format and/or protocol of the API of the identified network.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) mapping, by a service provider computing device, a first request associated with a first account from a secure remote initiator associated with a first party into a first message in a first format and protocol specific to an application programming interface (API) of a first network, via a first software development kit (SDK) associated with the service provider computing device; and (b) mapping, by the service provider computing device, a second request associated with a second, different account from the secure remote initiator associated with the first party into a second message in a second format and protocol specific to an API of a second network, via the first SDK, wherein the first format and protocol are different than the second format and protocol.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) transmitting a lookup request to a network for identifying information for a user in connection with a checkout request by the user at a first party; (b) receiving a user ID for the user from the network; (c) requesting validation of the user from the network based on the use ID; (d) receiving a one-time passcode (OTP) for the user from the network; (e) requesting and receiving a OTP from the user; (f) transmitting the OTP received from the user to the network, whereby the network validates the user based on the OTP from the network matching the OTP from the user; and (g) receiving a validation result token from the network indicative of the validation of the user.

As will be further appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving payment account details for a payment account associated with a user in connection with a checkout request by the user for an interaction at a first party; (b) identifying a payment network associated with the payment account; (c) requesting and receiving an encryption key from the identified payment network; (d) encrypting the payment account details for the payment account based on the encryption key; (e) transmitting the encrypted payment account details to the identified payment network and requesting enrollment of the payment account, by the identified payment network, for remote checkout; and (f) requesting checkout at the identified payment network, based on the enrolled payment account associated with the user and in response to the checkout request received from the user, whereby the identified payment network is able to process a network transaction in connection with the remote checkout request.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the phrase “at least one of” and the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in facilitating network interactions at a virtual location of a first party, the method comprising:
compiling, by a computing device, a list of accounts for a user;
for each of the accounts, appending, by the computing device, a network scheme identifier to the account or to a profile for the user in association with the account, the network scheme identifier indicative of a network to which the account is associated;
receiving, at the computing device, a selection of one of the accounts from the list of accounts in connection with a checkout;
identifying, by the computing device, the network associated with the selected one of the accounts based on the network scheme identifier for the selected one of the accounts; and
transmitting at least one message associated with the checkout to a software development kit (SDK) and/or an application programming interface (API) of the identified network, thereby allowing the identified network to process a network transaction in connection with the checkout.

2. The computer-implemented method of claim 1, wherein the identified account includes a payment account, and wherein the at least one message includes a checkout request for the network transaction.

3. The computer-implemented method of claim 1, wherein the at least one message includes one of a payload call, a confirmation call, and a registration call.

4. The computer-implemented method of claim 1, further comprising:
receiving a payload request from a service provider in connection with the network transaction; and
mapping the payload request into the at least one message in a type, format and/or protocol of the API of the identified network.

5. The computer-implemented method of claim 4, further comprising transmitting a payload from the identified network to the service provider, wherein the payload includes an account credential for the selected account.

6. The computer-implemented method of claim 1, wherein appending the network scheme identifier to the account in the list of accounts includes appending the network scheme identifier to said account based on a bank identification number (BIN) of an account number for said account.

7. A computer-implemented method for use in facilitating network interactions at a virtual location of a first party, the method comprising:
mapping, by a service provider computing device, a first request associated with a first account from a secure remote initiator associated with a first party into a first message in a first format and protocol specific to an application programming interface (API) of a first network, via a first software development kit (SDK) associated with the service provider computing device; and
mapping, by the service provider computing device, a second request associated with a second, different account from the secure remote initiator associated with the first party into a second message in a second format and protocol specific to an API of a second network, via the first SDK, wherein the first format and protocol are different than the second format and protocol.

8. The computer-implemented method of claim 7, further comprising:
receiving, by the service provider computing device, the first request in connection with a first checkout process, the first request including a first correlation ID;
requesting, by the service provider computing device, a payload from the first network, via the API of the first network and the mapped first request, when the first correlation ID is specific to the first network.

9. The computer-implemented method of claim 8, further comprising:
receiving, by the service provider computing device, the second request in connection with a second checkout process, the second request including a second correlation ID;
requesting, by the service provider computing device, a payload from the second network, via the API of the second network and the mapped second request, when the second correlation ID is specific to the second network.

10. The computer-implemented method of claim 9, wherein each of the first and second requests includes a payload request; and
wherein the method further comprises receiving account information, as part of the payload, from the first network in response to the first request.

11. The computer-implemented method of claim 7, further comprising assembling, by the service provider computing device, via a second SDK associated with the service provider computing device, a list of payment accounts from the first and second networks through a first call of a SDK of the first network including a token specific to a user and a second call of an SDK of the second network including the token specific to the user, wherein the list of payment accounts includes the first account and the second account.

12. The computer-implemented method of claim 7, further comprising, in connection with the first request and prior to mapping the first request into the first message:
receiving, by the service provider computing device, a one-time passcode (OTP) from a user associated with the first account;
validating, by the service provider computing device, with the first network, the user based at least in part on the OTP; and
receiving, by the service provider computing device, a token representative of validation of the user.

13. The computer-implemented method of claim 7, further comprising, in connection with the first request and prior to mapping the first request into the first message:
receiving, by the service provider computing device, account credentials for the first account from a user associated with the first account;
identifying, by the service provider computing device, the first network based on the account credentials for the first account; and
requesting, by the service provider computing, enrollment of the first account with the first network.

14. A non-transitory computer readable storage medium including executable instructions defining a package of software development kits (SDKs) including at least a first SDK and a second SDK, wherein when the executable instructions are executed by a processor of a service provider computing device, the executable instructions cause the processor to:
assemble a list of payment accounts for a user from first and second networks, via the first SDK, through a first call of a SDK of the first network including a token specific to the user and a second call of a SDK of the second network including the token specific to the user;
receive a first request associated with a first checkout by the user at a first party, based on a first one of the payment accounts, via the second SDK, from a secure remote initiator associated with the first party;
map the first request into a first message in a first format and protocol specific to an application programming interface (API) of the first network, via the second SDK;
receive a second request associated with a second checkout by the user at the first party, based on a second, different one of the payment accounts, via the second SDK, from the secure remote initiator associated with the first party;
map the second request into a second message in a second format and protocol specific to an API of the second network, via the second SDK, wherein the first format and protocol are different than the second format and protocol.

15. The non-transitory computer readable storage medium of claim 14, wherein the executable instructions, when executed by the processor, further cause the processor to:
for each of the payment accounts in the list of payment accounts, append, via the first SDK, a network scheme identifier to the payment account, the network scheme identifier indicative of a one of the first and second networks to which the payment account is associated;
identify, via the first SDK, the first network associated with the first one of the payment accounts based on the network scheme identifier appended to the first one of the payment accounts; and
identify, via the first SDK, the second network associated with the second one of the payment accounts based on the network scheme identifier appended to the second one of the payment accounts.

16. The non-transitory computer readable storage medium of claim 15, wherein the network scheme identifier appended to each of the payment accounts is based on a bank identification number (BIN) of an account number for said account.

17. The non-transitory computer readable storage medium of claim 14, wherein the executable instructions, when executed by the processor, further cause the processor to:
transmit the first message to the SDK and/or the API of the first network, thereby allowing the first network to process a network transaction in connection with the first checkout; and
transmit the second message to the SDK and/or the API of the second network, thereby allowing the second network to process a network transaction in connection with the second checkout.

18. The non-transitory computer readable storage medium of claim 14, wherein the first and second requests are first and second payload requests, and wherein the first payload request includes a first correlation ID specific to the first network and wherein the second payload request includes a second correlation ID specific to the second network; and
wherein the executable instructions, when executed by the processor, further cause the processor to:
request, via the second SDK, a payload from the first network, through the API of the first network and the first message, based on the first correlation ID; and
request, via the second SDK, a payload from the second network, through the API of the second network and the second message, based on the second correlation ID.

19. The non-transitory computer readable storage medium of claim 18, wherein the executable instructions, when executed by the processor, further cause the processor to:
receive account information for the first one of the payment accounts from the first network, in response to the first message for the payload from the first network; and
receive account information for the second one of the payment accounts from the second network, in response to the second message for the payload from the second network.
